(19) United States
(12) Patent Application Publication
(10) Pub. No.: US 2006/0014053 A1
(43) Pub. Date: Jan. 19, 2006

(54) Magnetic disk and magnetic disk device provided with the same

(75) Inventors: Makoto Asakura, Tokyo (JP); Yoichiro Tanaka, Kawasaki-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHBIA, Tokyo (JP)

(21) Appl. No.: 11/179,668

(22) Filed: Jul. 13, 2005

(30) Foreign Application Priority Data
Jul. 16, 2004 (JP) 2004-210462

(51) Int. Cl. G11B 5/706

(52) U.S. Cl. 428/848.1; 428/848.6

(57) ABSTRACT

A magnetic disk includes a flat disk-shaped substrate having a center hole and a recording region formed on an obverse and/or reverse surface of the substrate and patterned depending on the presence of a magnetic material. The recording region has a data region pattern and a plurality of servo region patterns formed substantially in circular arcs which radially extend from the center hole side of the substrate to an outer peripheral edge portion thereof and divide the data region pattern in a plurality of parts in the circumferential direction of the substrate. Each servo region pattern has a radius larger than that of the outmost periphery of the substrate and a center of the circular arc on a circular path concentric with the substrate. The data region pattern and each of the servo region patterns have different magnetic occupancies and different optical reflection factors.

### CROSS-REFERENCE TO RELATED APPLICATIONS

This application is based upon and claims the benefit of priority from prior Japanese Patent Application No. 2004-210462, filed Jul. 16, 2004, the entire contents of which are incorporated herein by reference.

### BACKGROUND OF THE INVENTION

1. Field of the Invention

This invention relates to a magnetic disk and a magnetic disk device provided with the same.

2. Description of the Related Art

In recent years, magnetic disk devices have been widely used as external recording devices of computers and image recording devices. In general, a magnetic disk device comprises a case in the form of a rectangular box. The case contains a magnetic disk for use as a magnetic recording medium, a spindle motor that supports and rotates the disk, magnetic heads for writing and reading information to and from the disk, and a head actuator that supports the heads for movement with respect to the disk. The case further contains a voice coil motor that rotates and positions the head actuator, a board unit that has a head IC and the like, etc. A printed circuit board for controlling the respective operations of the spindle motor, voice coil motor, and magnetic heads through the board unit is screwed to the outer surface of the case.

Further miniaturization of magnetic disk devices has recently been advanced so that they can be used as recording devices for a wider variety of electronic apparatuses, or smaller-sized electronic apparatuses in particular. Accordingly, magnetic disks are expected to be further reduced in size and enhanced in recording density. Proposed in Jpn. Pat. Appln. KOKAI Publication No. 2003-22634, for example, is a magnetic disk of the so-called discrete-track-recording (DTR) type, as a magnetic disk that is small-sized and ensures high-density recording. This DTR magnetic disk has rugged surfaces, and a magnetic material that can record data is formed on its projections. The surfaces of the magnetic disk are rugged and previously formed having patterned regions, including a servo region to which servo data are recorded and a data region to which a user can record data. A large number of projections or magnetic tracks are formed on the data region.

According to the DTR magnetic disk described above, the adjacent magnetic tracks are divided by recesses, so that crosstalk between the magnetic tracks can be prevented to ensure high-density recording. In the DTR magnetic disk, the magnetic tracks are distributed at a high density such that their pitch is not lower than the visible light wavelength. Therefore, rainbows such as interference fringes cannot be seen, so that a recording surface of the magnetic disk cannot be recognized visually. Thus, in the case of a single-sided disk, the recording surface cannot be identified. In incorporating the magnetic disk into a magnetic disk drive or the like, therefore, it is hard accurately to set its position relative to the magnetic head.

In increasing the recording capacity, the recording layer should preferably be provided on each side of the magnetic disk. For the same reason as aforesaid, however, the side, obverse or reverse, of the magnetic disk cannot be discriminated with ease. Also in this case, it is hard appropriately to orient the magnetic disk when it is incorporated into a magnetic disk device.

### BRIEF SUMMARY OF THE INVENTION

According to an aspect of the invention, there is provided a magnetic disk comprising a disk-shaped substrate having a center hole; and recording regions provided individually on obverse and reverse surfaces of the substrate, the recording regions having patterned magnetic material shapes, the respective pattern shapes of the recording regions on the obverse and reverse sides being different.

According to another aspect of the invention, there is provided a magnetic disk device comprising:

a magnetic disk which comprises a disk-shaped substrate having a center hole, and recording regions provided individually on obverse and reverse surfaces of the substrate, the recording regions having patterned magnetic material shapes, the respective pattern shapes of the recording regions on the obverse and reverse sides being different;

a drive unit which supports and rotates the magnetic disk at a constant speed;

a head which performs information processing for the magnetic disk; and

a head actuator which radially moves the head with respect to the magnetic disk, the magnetic disk being located in a direction such that each of the servo region patterns and a movement path of the head on the magnetic disk are in line with each other.

### BRIEF DESCRIPTION OF THE SEVERAL VIEWS OF THE DRAWING

FIG. 1A is a plan view showing a surface pattern of a magnetic disk according to an embodiment of the invention;

FIG. 1B is a plan view showing a reverse pattern of the magnetic disk;

FIG. 2 is an enlarged perspective view, partially in section, showing a data region pattern of the magnetic disk;

FIG. 3 is a diagram typically showing a servo region pattern of the magnetic disk;

FIG. 4 is a diagram schematically showing optical reflection factors of a data region pattern and a servo region pattern of the magnetic disk;

FIG. 5 is an exploded perspective view showing an HDD according to the embodiment of the invention;

FIG. 6 is a block diagram schematically showing a configuration of the HDD;

FIG. 7 is a diagram illustrating head positioning control in the HDD; and

FIG. 8 is a diagram illustrating address detection processing in a channel of the HDD.

### DETAILED DESCRIPTION OF THE INVENTION

A magnetic disk according to an embodiment of this invention will now be described in detail with reference to the accompanying drawings.

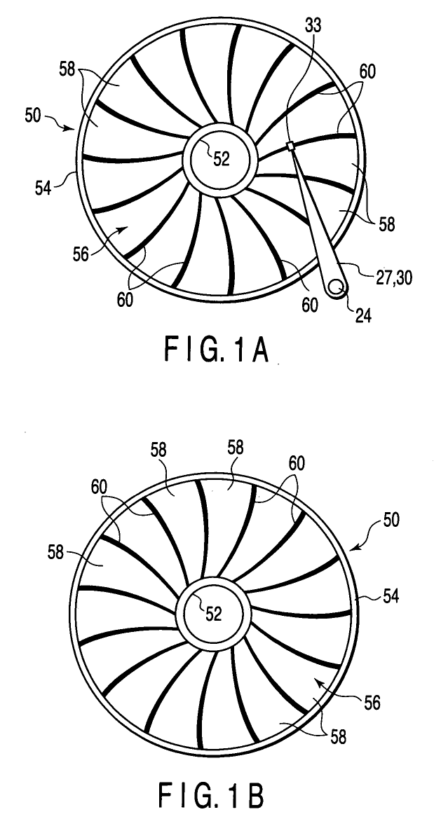

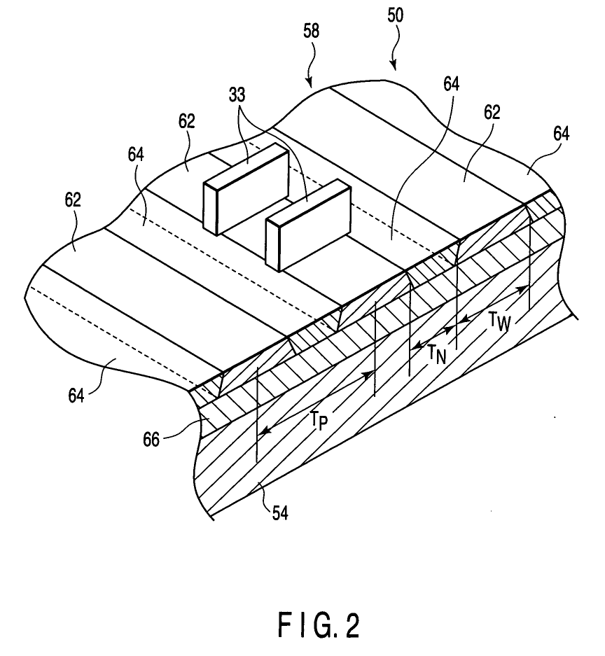

As shown in FIGS. 1A, 1B and 2, a magnetic disk 50 according to the present embodiment comprises a substrate 54 in the form of a flat disk having a center hole 52 and recording layers 56 formed on at least one surface of the substrate (obverse and reverse surfaces of the substrate in this case). Each of the recording layers 56, which constitutes a recording region, has the form of a ring that coaxially covers all the area of the substrate 54 except its inner and outer peripheral edge portions. Each recording layer 56 is formed of a ferromagnetic material, e.g., CoCrPt, and is patterned. Those regions of the layer which have no magnetic material are filled with a nonmagnetic material, e.g., SiO₂. Thus, the resulting magnetic disk has a leveled surface and serves for perpendicular magnetic recording.

The magnetic disk 50 is formed as a DTR medium. FIG. 1A shows a pattern of the recording layer 56 on the obverse side of the disk 50. FIG. 1B shows a pattern of the layer 56 on the reverse side of the disk 50. Roughly speaking, each pattern of the recording layer 56 includes a data region pattern 58 and a plurality of servo region patterns 60.

As shown in FIG. 2, the substrate 54 is formed of glass, for example, and has a base layer (SUL) 66 on each of its obverse and reverse surfaces. The substrate 54 may be formed of aluminum in place of glass. The data region pattern 58 and the servo region patterns 60 are formed on each base layer 66.

The data region pattern 58 forms a recording region where user data are recorded and reproduced by a head of a magnetic disk device (mentioned later), and is composed of projections of a magnetic material on the surface of the substrate 54. More specifically, the data region pattern 58 has a plurality of circular ring-shaped magnetic tracks 62 that serve as perpendicular recording layers of a ferromagnetic material (CoCrPt). These magnetic tracks 62 are arranged substantially coaxially with the center hole 52 and side by side at predetermined periods or track pitches Tp in the radial direction of the substrate 54.

The magnetic tracks 62 that adjoin in the radial direction of the substrate 54 are divided by nonmagnetic guard belt portions 64 in the form of recesses to which data cannot be recorded. According to the present embodiment, SiO₂ is implanted in the nonmagnetic guard belt portions 64 in order to level the disk surface. Further, a thin carbon protective film is formed on the magnetic disk surface, and it is coated with a lubricant. A protective layer may be formed directly on the irregular surface without embedding the guard belt portions 64 in the surface.

A radial width Tw of each magnetic track 62 that extends in the radial direction of the substrate 54 is larger than a width TN of each nonmagnetic guard belt portion 64. In the present embodiment, the ratio of the radial width of each magnetic track 62 to that of each nonmagnetic guard belt portion 64 is 2:1, and the data region pattern 58 has a magnetic occupancy of 67%. Since the data region pattern 58 has a high track density exceeding 120 kTPI, for example, the radial pattern period (track pitch) Tp is shorter than a visible light wavelength. Thus, a rainbow pattern that is formed by light diffraction by the magnetic tracks 62 cannot be visually recognized in the magnetic disk 50.

As shown in FIGS. 1A and 1B, the ring-shaped magnetic tracks 62 that constitute the data region pattern 58 are sectored in the circumferential direction of the substrate 54 by the servo region patterns 60. In these drawings, the data region pattern 58 is shown to be divided in fifteen sectors. Actually, however, the data region pattern 58 is divided in 100 servo sectors or more.

Each servo region pattern 60 is a prebid region in which necessary information for positioning the head of the magnetic disk device is implanted in a magnetic or nonmagnetic manner. Each servo region pattern 60 has an arcuate shape that coincides with a movement path of the head. Further, each servo region pattern 60 is a circumferentially extended pattern such that its circumferential length along the circumference of the substrate 54 increases in proportion to the radial position on the substrate, that is, a region on the outer peripheral side of the substrate is longer. The servo region patterns 60 of the obverse-side recording layer 56 of the substrate 54 and the servo region patterns 60 of the reverse-side recording layer 56 are arranged in different orders in the circumferential direction. For example, the patterns on the obverse side are arranged in the counterclockwise direction, and those on the reverse side in the clockwise direction. Thus, the recording regions of the magnetic disk 50 have patterned magnetic material shapes, one on the obverse side and another on the reverse.

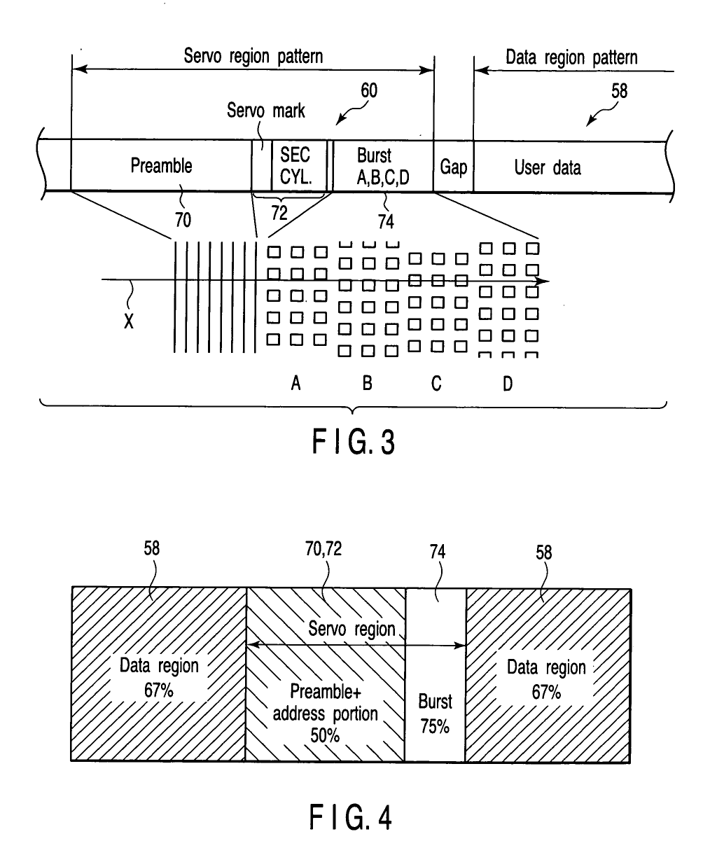

One of the servo region patterns 60 will now be described in detail with reference to FIG. 3.

FIG. 3 shows the servo region pattern 60 that is provided on the obverse side of the magnetic disk 50. This servo region pattern 60 is a pattern in a position where the head passes from left to right of FIG. 3 in a passing direction X when the magnetic disk 50 is set in a drive. If the pattern 60 is represented by an arcuate servo region pattern shape, circular arcs on the outer and inner peripheral sides are situated on the left- and right-hand sides, respectively, of FIG. 3. The data region pattern 58 is located on either side of the servo region pattern 60.

Roughly speaking, the servo region pattern 60 has a preamble portion 70, an address portion 72, and a burst portion 74 for deviation detection. Like the data region pattern 58, it is composed of magnetic patterns formed of ferromagnetic projections and nonmagnetic patterns formed of recesses between the magnetic patterns.

The preamble portion 70 is provided to perform PLL processing and AGC processing. In the PLL processing, clocks for servo signal reproduction are synchronized with time delays that are caused by rotation eccentricity or the like of the magnetic disk 50. The AGC processing serves to maintain an appropriate signal reproduction amplitude. The preamble portion 70 is formed as a repetitive pattern region that is substantially radially continuous at least in the radial direction of the substrate 54 and includes magnetic and nonmagnetic portions arranged alternately in the circumferential direction of the substrate 54. The magnetic-nonmagnetic ratio of the preamble portion 70 is substantially 1:1, that is, its magnetic occupancy is about 50%. The circumferential repetition period, which varies in proportion to the radial distance, is not longer than the visible light wavelength even in an outermost peripheral portion of the substrate 54. As in the case of the data region pattern, it is hard to identify the servo region pattern by light diffraction.

In the address portion 72, a servo signal recognition code called a servo mark, sector information, cylinder information, etc. are formed in Manchester codes that are arranged at the same pitches as the circumferential pitches of the preamble portion 70. The cylinder information has a pattern such that it changes with every servo track. In order to lessen the influence of a mistake in address reading during head seek operation, therefore, the information is Manchester-encoded and recorded after code conversion is performed such that variations from adjacent tracks called Gray codes are minimal. The magnetic occupancy of the address portion 72 is about 50%.

The burst portion 74 is an off-track detection region for detecting an off-track deviation from an on-track state of a cylinder address. It is formed with four marks or bursts A, B, C and D whose pattern phases are shifted in the radial direction. Each burst has a plurality of marks that are arranged at the same pitch periods as the preamble portion in the circumferential direction. A radial period is proportional to the change period of an address pattern, that is, to a servo track period. In the present embodiment, each burst is formed for 10 periods in the circumferential direction. In the radial direction, its patterns are repeated with a period twice as long as the servo track period. The magnetic occupancy of A, B, C and D burst patterns is about 75%.

Basically, each mark is designed for a rectangle, or more strictly, a parallelogram based on a skew angle at the time of head access. Depending on the machining performance, such as the stamper working accuracy, transfer formation, etc., however, the marks are somewhat rounded. Further, the marks are formed as nonmagnetic portions.

A detailed description of the principle of position detection based on the burst portion 74 is omitted. The off-track deviation is calculated by arithmetically processing an average amplitude value of reproduction signals for the burst portions A, B, C and D. Although the A, B, C and D burst patterns are used in the present embodiment, they may be replaced with conventional phase difference servo patterns or the like that are arranged as off-track detecting means. However, the magnetic occupancy of the phase difference servo patterns is about 50%.

In the case of a magnetic disk that has a low-density pattern with a track pitch of 400 nm or more, optical diffraction is caused by irregular track patterns if the substrate is roughened so that whole surface of a magnetic layer is irregular. Thus, reflected light from the data region pattern can be visually recognized as a rainbow-like diffracted light. In this case, the arcuate servo region pattern shape can be visually recognized with ease.

In the case of a magnetic disk that has a track pitch shorter enough than the visible light wave-length, optical diffraction never occurs, so that it is hard to recognize a rainbow pattern. If the whole surface of the magnetic layer is made irregular, therefore, it is difficult visually to recognize the servo and data regions.

If the recording layers have magnetic and nonmagnetic patterns, as in the magnetic disk 50 according to the present embodiment, on the other hand, the lower the magnetic occupancy of the patterns, the lower the intensity of reflected light is. This is because magnetic and nonmagnetic portions have somewhat different reflection factors. Also, this characteristic is attributable to influences of multi-path reflection from the embedded nonmagnetic portion and absorbance.

Thus, even in the case of a high-density pattern from which optical diffraction cannot be expected, the arcuate traces of the servo region patterns 60 can be optically discriminated by a difference in reflected light intensity. This can be done in a manner such that a certain or greater difference in magnetic occupancy is provided between the data region pattern 58 and the servo region patterns 60.

If there is a difference of about 10% in optical reflection factor, the patterns can be discriminated satisfactorily. In the present embodiment, the magnetic occupancy of the data region pattern 58 is about 67%, while the respective magnetic occupancies of the preamble portion 70 and the address portion 72 of each servo region pattern 60 are 50%. Thus, the difference in reflection factor from the data region pattern is great enough for the optical recognition of the servo region patterns.

FIG. 4 shows an optical microscope image near the servo region pattern 60. The magnetic tracks 62, fine patterns, etc. are invisible. The preamble portion 70 and the address portion 72 of the servo region pattern 60 can be optically recognized even if they are darker and denser than the data region pattern 58. Arcuate servo patterns can be discriminated more clearly through a polarizing filter, for example.

A preferable line width that can be visually recognized is 10 μm or more. Preferably, therefore, the length of the combination of the preamble portion 70 and the address portion 72 of the innermost peripheral servo sector should be 0.01 mm or more. The line width of 10 μm is a visible limit and cannot be regarded as easily identifiable by eyes. However, the circumferential lengths of the servo region patterns 60 increase with distance from the inner periphery, depending on the radial position on the substrate, and line widths of the inner and outer peripheral portions are about 10 μm and 20 μm, respectively. The servo region patterns 60 can be easily visually observed by being enlarged at a low magnification through a magnifying glass. Thus, the length of the combination of the preamble portion and the address portion of the innermost peripheral servo sector is adjusted to 0.01 mm or more. In the present embodiment, the repetition frequency and circumferential pitch of the preamble portion 70 are adjusted so that the line width is 50 μm or more that can be directly visually recognized with ease without using any magnifying microscope or the like.

As mentioned before, each servo region pattern 60 is substantially in the shape of a circular arc. This servo region pattern shape is effective in discriminating the obverse and reverse of the magnetic disk 50. If the servo region pattern is perfectly radial, it is symmetrical. Although the servo region patterns on each disk surface can be discriminated, therefore, the side, obverse or reverse, on which the patterns are formed cannot be identified. Since the servo region patterns 60 are formed in the head passing direction X, as shown in FIG. 3, servo information cannot be easily identified if the side of the magnetic disk is mistaken. In an assembly process in which the magnetic disk 50 having the servo region patterns 60 previously formed thereon is incorporated in the magnetic disk device as the drive, it is essential to set the disk 50 without mistaking its side. Thus, it is effective to form the arcuate servo region patterns by which the side, obverse or reverse, of the magnetic disk 50 can be recognized with ease.

Besides, the movement path of the head of the magnetic disk device is an arcuate path around a rotary drive mechanism, which will be mentioned later. Preferably, therefore, the servo region patterns 60 of the magnetic disk 50 should be arcuate patterns that are substantially coincident with the head movement path.

The following is a brief description of a method of manufacturing the magnetic disk 50 described above. Manufacturing processes include a transfer process, a magnetic processing process, and a finishing process. First, a method of manufacturing a stamper that constitutes a base of a pattern used in the transfer process will be described.

A method of manufacturing a stamper can be divided into steps of drawing, development, electro-forming, and finishing. In the pattern drawing, a part of the magnetic disk to be demagnetized is exposed for drawing from its inner periphery to outer periphery on a resist-coated matrix by using an electron beam exposure unit of a matrix-rotation type. The resulting structure is subjected to development, RIE, etc. to form a matrix with irregular patterns. After this matrix is treated for electrical conductibility, its surface is electroformed with nickel. Subsequently, the nickel is separated from the matrix, and a disk-shaped stamper of nickel is formed by punching for inside and outside diameters. The stamper has projections on those parts which are to be demagnetized. Stampers for the obverse and reverse surfaces of the magnetic disk are formed individually.

In the transfer process, the irregularities of the stamper are transferred to the magnetic disk by the imprint lithography using an imprinter of a synchronous double-sided transfer type. More specifically, base layers are first formed individually on the opposite sides of the substrate 54 that is formed of glass or silicon, and magnetic layers of a ferromagnetic material are further formed overlapping the base layers.

A resist is applied to both surfaces of the perpendicular-recording magnetic disk by spin coating. After the disk is baked, it is chucked by its center hole 52. For example, liquid SiO₂ (SOG) is used as the resist. In this state, the opposite sides of the magnetic disk are sandwiched between two types of stampers that are provided for the reverse and obverse surfaces, individually, whereby the whole surfaces are pressed uniformly. Thus, the irregular patterns of the stampers are transferred to the resist surface. By this transfer process, the parts to be demagnetized are formed as recesses in the resist.

Then, in the magnetic processing process, the magnetic layer surface of the parts to be demagnetized is exposed after the residual resist at the respective bottoms of the recesses of the resist is removed. At that part where the magnetic layer is to be left, the resist is formed as projections. Then, only those parts of the magnetic layer which are situated corresponding to the recesses are removed by ion milling using the resist as a guard layer, whereby the magnetic material is worked into a desired pattern.

Subsequently, SiO₂ films are formed individually to an adequate thickness on the opposite surfaces of the magnetic disk by, for example, sputtering, thereby eliminating the irregularities of the disk surfaces. By removing the SiO₂ films to the depth of the magnetic layer surfaces by reverse sputtering, the flat pattern magnetic disk can be obtained having the recesses filled with the nonmagnetic material.

In the final finishing process, the disk surfaces are polished further to improve the levelness, and the carbon protective film is formed thereafter. The magnetic disk according to the present embodiment is completed by further application of the lubricant.

The following is a description of a hard disk drive (HDD) as the magnetic disk device that is provided with the magnetic disk 50 described above.

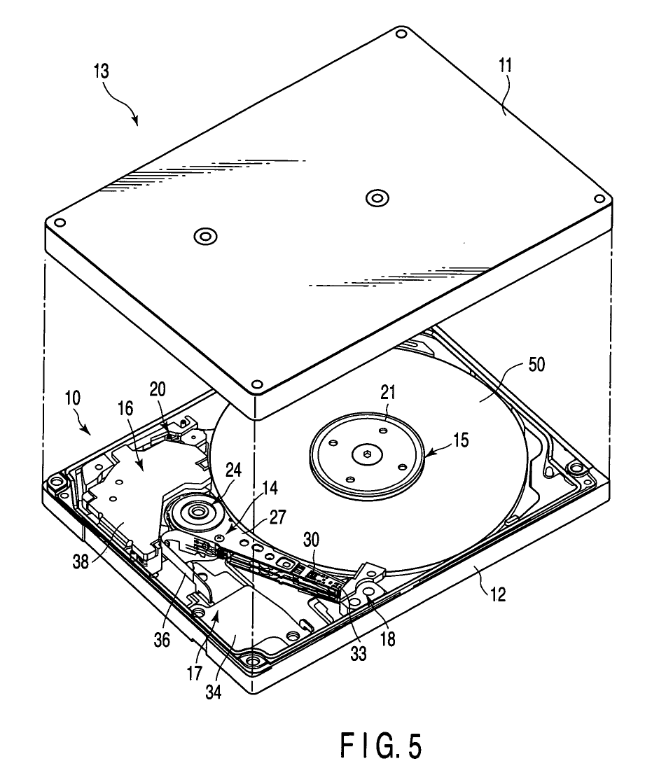

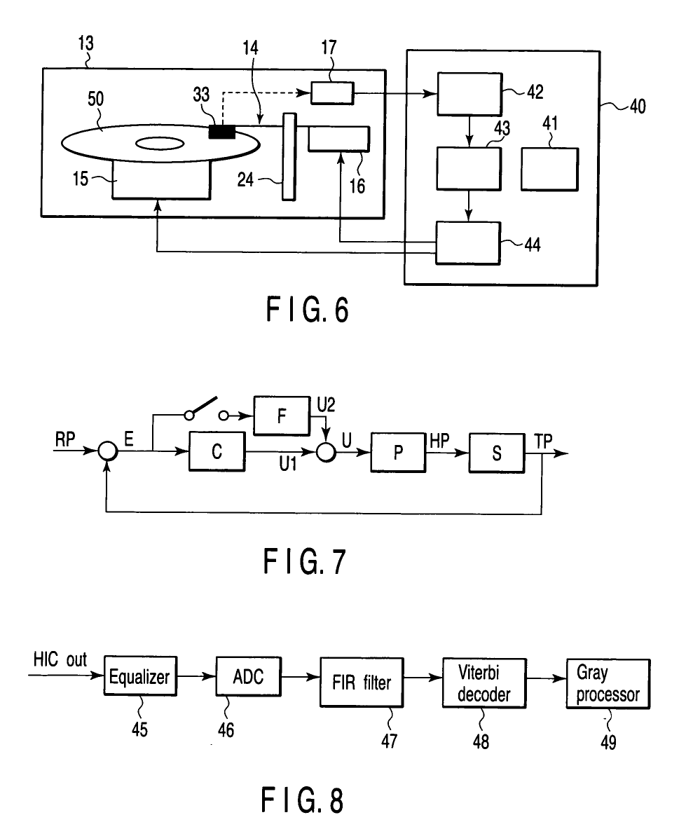

As shown in FIGS. 5 and 6, a magnetic disk device 10 comprises a flat, rectangular disk enclosure 13. The enclosure 13 has a box-shaped base 12 and a top cover 11 that hermetically closes a top opening of the base 12.

The disk enclosure 13 contains the magnetic disk 50, a spindle motor 15, magnetic heads 33, and a head actuator 14. The spindle motor 15 supports and rotates the disk. The magnetic heads 33 are used to record and reproduce information to and from the disk. The head actuator 14 supports the magnetic heads for movement with respect to the magnetic disk 50. The enclosure 13 further contains a voice coil motor (hereinafter, referred to as a VCM) 16, a ramp load mechanism 18, an inertia latch mechanism 20, and a flexible printed circuit board unit (hereinafter, referred to as an FPC unit) 17. The VCM 16 rotates and positions the head actuator 14. The ramp load mechanism 18 holds the magnetic heads 33 in a position off the magnetic disk 50 when the heads are moved to the outermost periphery of the disk. The inertia latch mechanism 20 holds the head actuator 14 in a shunt position. The FPC unit 17 is mounted with circuit components, such as a preamplifier. The base 12 has a bottom wall, and the spindle motor 15, head actuator 14, VCM 16, etc. are arranged on the inner surface of the bottom wall.

As mentioned before, the magnetic disk 50 is a small-diameter patterned medium with a perpendicularly magnetized dual-film structure, both surfaces of which are processed for DTR. More specifically, the disk 50 has recording layers 56 on its obverse and reverse surfaces. It is formed having a diameter of 1.8 or 0.85 inch. The magnetic disk 50 is coaxially fitted on a hub (not shown) of the spindle motor 15 and fixed to the hub by a clamp spring 21. The magnetic disk 50 is supported and rotated at a given speed by the spindle motor 15 as a driver unit.

The head actuator 14 has a bearing portion 24 fixed on the bottom wall of the base 12, two arms 27 attached to the bearing portion, and suspensions 30 extending individually from the arms. The magnetic heads 33 are supported individually on the respective extended ends of the suspensions 30. The arms 27, suspensions 30, and heads 33 are supported for rotating motion around the bearing portion 24. The heads 33 include a down-head that faces the obverse-side recording layer of the magnetic disk 50 and an up-head that faces the reverse-side recording layer of the disk. In each magnetic head 33, a slider for use as a head body is mounted with a magnetic head element that includes a read element (GMR element) and a write element.

The VCM 16 has a voice coil 22 attached to the head actuator 14, a pair of yokes 38 fixed to the base 12 and opposed to the voice coil, and a magnet (not shown) fixed to one of the yokes. The VCM 16 generates a rotational torque around the bearing portion 24 in the arms 27 and moves the magnetic heads 33 in the radial direction of the magnetic disk 50.

The FPC unit 17 has a rectangular board body 34 that is fixed on the bottom wall of the base 12. Electronic components, connectors, etc. are mounted on the board body. The FPC unit 17 has a belt-shaped main flexible printed circuit board 36 that electrically connects the board body 34 and the head actuator 14. The magnetic heads 33 that are supported by the head actuator 14 are connected electrically to the FPC unit 17 through a relay FPC (not shown) and the main flexible printed circuit board 36.

As mentioned before, the magnetic disk 50 has the obverse and reverse sides and is set in the base 12 with the obverse and reverse sides aligned so that the head movement path of the magnetic disk device is substantially coincident with the arcuate shape of the servo region patterns 60 of the magnetic disk. The specifications of the magnetic disk 50 fulfill outside and inside diameters, recording and reproducing characteristics, etc. that are adaptive to the magnetic disk device. Each arcuate servo region pattern 60 has its center of circular arc on the circumference of a circle that is concentric with the magnetic disk and has its radius equivalent to the distance from the rotation center of the magnetic disk to the center of the bearing portion 24 of the head actuator 14. The radius of the circular arc is equivalent to the distance from the bearing portion 24 to each magnetic head 33. In other words, each servo region pattern 60 has the shape of a circular arc that is always substantially coincident with the head movement path even when the magnetic rotates. The radius of the circular arc of each servo region pattern 60 is equivalent to the distance from the bearing portion 24 to each magnetic head 33. The center of the circular arc moves along a circular path that is concentric with the magnetic disk and varies in synchronism with the angle phase on the disk on which the patterns are formed. The radius of the path of the center of the circular arc is equivalent to the distance from the center of the spindle motor 15 to the center of the bearing portion 24.

A printed circuit board (hereinafter, referred to as a PCB) 40 for controlling the respective operations of the spindle motor 15, VCM 16, and magnetic heads through the FPC unit 17 is fixed to the outer surface of the bottom wall of the base 12, and faces the base bottom wall.

As shown in FIG. 6, a large number of electronic components are mounted on the PCB 40. These electronic components mainly include four system LSI's, a hard disk controller (hereinafter, referred to as a HDC) 41, a read/write channel IC 42, an MPU 43, and a motor driver IC 44. Further, the PCB 40 is mounted with a connector that can be connected to a connector on the side of the FPC unit 17 and a main connector for connecting the HDD to an electronic apparatus such as a personal computer.

The MPU 43 is a controller of a drive operating system and includes a ROM, RAM, CPU, and logic processor, which realize a positioning control system according to the present embodiment. The logic processor is an arithmetic processor composed of a hardware circuit and is used for high-speed arithmetic processing. Further, operating software (FW) is saved in the ROM, and the MPU controls the drive in accordance with this FW.

The HDC 41 is an interface section in the HDD. It exchanges information with an interface between the disk drive and a host system, e.g., a personal computer, the MPU 43, the read/write channel IC 42, and the motor driver IC 44, thereby managing the whole HDD.

The read/write channel IC 42 is a head signal processor associated with read/write operation. It is composed of a circuit that switches channels of a head amplifier IC and processes recording and reproducing signals, such as read/write signals. The motor driver IC 44 is a drive unit for the VCM 16 and the spindle motor 15. It drivingly controls the spindle motor for constant rotation and applies a VCM manipulated variable from the MPU 43 as a current value to the VCM, thereby driving the head actuator 14.

A configuration of a head positioning controller will now be described in brief with reference to FIG. 7.

FIG. 7 is a block diagram of the head positioning controller. In FIG. 7, symbols C, F, P and S individually designate transfer functions of the system. Specifically, a control object P is equivalent to the head actuator 14 that includes the VCM 16, while a signal processor S is an element that is realized by a channel IC and an MPU (part of off-track detecting means).

A control processor includes a feedback controller C (first controller) and a synchronous suppression/compensation section (second controller), and specifically, is realized by an MPU.

The operation of the control processor will be described in detail later. The signal processor S generates track current position (TP) information on the magnetic disk 50 in accordance with a reproducing signal including address information from the servo region patterns 60 right under a head position (HP). Based on a target track position (RP) on the magnetic disk 50 and a position error (E) between the target track position and a current position (TP) of each magnetic head 33 on the magnetic disk 50, the first controller C outputs an FB control value U1 in a direction to lessen the position error.

The second controller F is an FF compensation section for correcting the shape of the magnetic track on the magnetic disk 50, vibration that is synchronous with the disk rotation, etc. It saves a previously calibrated rotation synchronous compensation value in a memory table. Normally, the second controller F never uses the position error (E), and outputs an FF control value U2 based on servo sector information (not shown) from the signal processor S with reference to the table. The control processor adds up the respective outputs U1 and U2 of the first and second controllers C and F, and supplies the resulting value as a control value U to the VCM 16 through the HDC 41, thereby driving the magnetic heads 33.

The rotation synchronous compensation value table is calibrated in an initial stage of operation. If the position error (E) becomes larger than a preset value, the table starts to be calibrated again, whereupon the synchronous compensation value is updated.

An operation for detecting the position error by the reproducing signal will now be described in brief with reference to FIG. 7.

The magnetic disk 50 is rotated at a fixed rotational speed by the spindle motor 15. The magnetic heads 33 are elastically supported by gimbals that are attached to the suspensions 30. They are designed to fly with a fine gap above the magnetic disk surface, balanced by an air pressure that is generated as the disk rotates. Thus, a head reproducing element can detect a magnetic flux leakage from the disk magnetic layer with a given magnetic gap above the disk surface.

As the magnetic disk 50 rotates, its servo region patterns 60 pass right under the magnetic heads 33 in a given period. Fixed-period servo processing can be executed by detecting track position information from reproducing signals for the servo region patterns.

Once the HDC 41 recognizes one of servo region pattern identification flags called servo marks in the servo region patterns 60, the timing for the arrival of each servo region pattern can be anticipated, since the servo marks are arranged at predetermined intervals. Accordingly, the HDC 41 urges the channel to start servo processing when the preamble portion 70 comes right under the magnetic head.

The following is a description of an address reproduction processing configuration in the channel. As shown in FIG. 8, an output signal from a head amplifier IC (HIC) that is connected to the magnetic heads 33 is read by the channel IC. After it is subjected to longitudinal signal equalization by an analog filter as an equalizer 45, the signal is sampled as a digital value by an ADC 46.

A magnetic field leakage from the magnetic disk 50 is perpendicular magnetization and is a magnetic/nonmagnetic pattern. However, DC offset components are thoroughly removed by the high-pass characteristic of the HIC and equalizer processing of a front-stage portion of the channel IC for longitudinal equalization. Thus, an analog filter post-output from the preamble portion 70 is substantially a false sine wave. A difference from a conventional perpendicular magnetic medium lies in that the signal amplitude is halved.

The magnetic disk according to the present embodiment is not limited to a patterned medium. However, selection of the direction of the magnetic flux leakage of the servo region patterns may cause misidentification of 1 or 0, and hence, failure in code detection in the channel. Thus, the magnetic disk polarity can be properly set according to the magnetic flux leakage of the patterns.

In the channel IC, the processing is switched depending on its reproducing signal phase. A reproducing signal clocks are synchronized with medium pattern periods in pull-in processing. Sector cylinder information is read in address reading processing. Burst portion processing is carried out as necessary information for off-track detection.

A detailed description of the pull-in processing is omitted. In this processing, the timing for sampling the ADC is synchronized with a sine-wave reproducing signal, and AGC processing is performed to adjust the signal amplitudes of digital sample values to a certain level. Periods 1 and 0 of a disk pattern are sampled at four points.

Then, in reproducing the address information, noises of the sample valued are lowered by a FIR filter 47. The sample values are converted into sector information and track information through Viterbi decoding processing based on maximum likelihood estimation by a Viterbi decoder 48 or gray code reverse conversion by a gray processor 49. Thus, servo track information of the magnetic heads 33 can be obtained.

Subsequently, in the burst portion 74, the channel proceeds to off-track detection processing. The signal amplitudes are subjected to sample-hold integral processing in the order of the burst signal patterns A, B, C and D, and a voltage value equivalent to an average amplitude is outputted to the MPU 43, whereby a servo processing interrupt is issued to the MPU. On receiving this interrupt, the MPU 43 reads the burst signals in the time series by an internal ADC, and converts them into off-track values by DSP. Based on these off-track values and the servo track information, the servo track positions of the magnetic heads 33 are detected precisely.

According to the magnetic disk 50 and the HDD constructed in this manner, the side, obverse or reverse, of the magnetic disk can be visually recognized, and the assembly of the disk device can be easily managed without failing to be aware of the side by the supplied medium. Further, each servo region pattern is formed in the shape of a circular arc corresponding to the head movement path. This is advantageous to the seek performance and the prevention of lowering of SN ratios at the inner and outer peripheries of the disk, so that the performance of the magnetic disk device can be improved.

A DTR system is a magnetic recording system in which error rates in data regions can be improved and the surface recording density can be increased. The increased recording density leads to an increase in recording capacity. Since the servo information, along with data tracks, is formed by implantation, the medium never requires servo information recording (STW: servo track write), which is an advantage of the use of the patterned medium to the HDD.

More specifically, the magnetic disk 50 has the arcuate servo region patterns 60 that depend on the configuration of the HDD, and its obverse and reverse are oriented as it is incorporated in the HDD. Accordingly, the magnetic disk 50 can produce the following functions and effects.

First, the magnetic disk 50 can ensure high seek performance. As mentioned before, the HDC 41 requests the channel to start serve processing at a timing when any of the servo region patterns 60 comes right under the magnetic head 33. If the servo region patterns are arranged at equal spaces and if the magnetic heads 33 are fixed in the radial direction, the resulting timing error is within an allowable range and negligible despite some fluctuation of a servo region pattern crossing period that is attributable to eccentric mounting of the magnetic disk. However, the magnetic heads 33 move in a circular arc as they move at high speed in the radial direction of the magnetic disk 50 during seek operation, for example. Thus, the magnetic heads move in the circumferential direction as well as in the radial direction and arouse a problem.

If the servo region patterns are formed perfectly radially, for example, they are situated in fixed angle phases without depending on the radial position. Since the magnetic heads 33 also move in the circumferential direction, however, the angle phases vary with respect to the rotation center of the spindle motor 15. Thus, a servo starting phase (distance from a servo region starting position in which a reproducing head is situated when a servo gate is booted) as viewed from the magnetic head side changes. This phase difference is settled depending on the seek speed, error in the magnetic head path, and control period. If the phase difference exceeds an allowable range, it is hard to fetch servo signals at the preamble portion 70. Possibly, therefore, the servo mark (SAM) at the head of the address portion 72 may fail to be detected, thus resulting in a servo loss error.

The occurrence of the servo loss error can be prevent even during high-speed seek operation by estimating a timing error time from the seek speed and the cylinder information and correcting a servo gate rise time. In this case, however, the servo characteristic is changed by a fluctuation of the control period, so that the seek performance lowers inevitably. High-speed seek can be effectively enabled by forming the servo region patterns in a circular arc after the head movement path.

Secondly, the difference in the servo information detection SN between the inner and outer peripheries of the magnetic disk 50 can be reduced. The servo information detection SN at the inner periphery of the disk 50 is inevitably lowered due to a high linear recording density even though the servo region patterns 60 are arranged along the magnetic head movement path. If the servo region patterns are perfectly radial, however, the SN ratio on the inner peripheral side of the magnetic disk lowers drastically. A simulation indicates that the SN ratio at the outer peripheral portion of the disk also lowers. This is attributable to the skew angle of the magnetic heads. More specifically, the servo signals are applied with a skew to the magnetic heads, so that the build-up of the servo signals is degraded and entails a reduction of the amplitude.

In the case of a small-diameter magnetic disk, in particular, servo signal clocks are enhanced to a maximum in order to increase the format efficiency. Accordingly, lowering of the SN ratio at the innermost periphery of the magnetic disk directly influences address reading, off-track detection accuracy, etc. As in the present embodiment, therefore, the shapes of the servo region pattern 60 that advance parallel to the magnetic heads 33 are essential. In the present embodiment, prebid-length signal clocks of the servo region patterns are set in accordance with the circumferential length of the visually recognizable patterns, the detection SN at the inner peripheral portion of the magnetic disk, and the rotational speed of the spindle motor.

This invention is not limited directly to the embodiment described above, and its components may be embodied in modified forms without departing from the scope or spirit of the invention. Further, various inventions may be made by suitably combining a plurality of components described in connection with the foregoing embodiment. For example, some of the components according to the foregoing embodiment may be omitted. Furthermore, components according to different embodiments may be combined as required.

In the foregoing embodiment, the optical reflection factor of the data region pattern of the magnetic disk is higher than that of the servo region patterns. However, it is necessary only that the respective optical reflection factors of these patterns be different. In the case of a patterned medium (one-dot, one-bit type) in a limited sense, the magnetic occupancy of the data region pattern is rather lowered to about 30%, and the quantity of reflected light from the data region pattern is smaller than that from the servo region patterns. Owing to the imprint manufacture, moreover, the marks of the burst portions are magnetic, and the magnetic occupancy of the burst regions is 25%.

Further, the number of magnetic disk(s) in the HDD is not limited to one but may be increased as required.

What is claimed is:

1. A magnetic disk comprising:
a disk-shaped substrate having a center hole; and
recording regions provided individually on obverse and reverse surfaces of the substrate,
the recording regions having patterned magnetic material shapes, the respective pattern shapes of the recording regions on the obverse and reverse sides being different.

2. A magnetic disk comprising:
a flat disk-shaped substrate, having obverse and reverse surfaces and a center hole, and a recording region formed on at least one of the obverse and reverse surface and patterned depending on the presence of a magnetic material,
the recording region having a data region pattern and a plurality of servo region patterns formed substantially in circular arcs which radially extend from the center hole side of the substrate to an outer peripheral edge portion thereof and divide the data region pattern in a plurality of parts in the circumferential direction of the substrate,
each of the servo region patterns having a radius larger than that of the outmost periphery of the substrate and a center of a circular arc on a circular path concentric with the substrate, a circumferential length of the servo region pattern in the circumferential direction of the substrate being increased with distance from the center hole,
the data region pattern and each of the servo region patterns having different magnetic occupancies and different optical reflection factors.

3. A magnetic disk according to claim 2, wherein each of the servo region patterns has a repetitive pattern region which is substantially radially continuous at least in the radial direction of the substrate and includes magnetic and nonmagnetic portions arranged alternately in the circumferential direction of the substrate, the respective optical reflection factors of the repetitive pattern region and the data region pattern differing by 10% or more from each other.

4. A magnetic disk according to claim 2, wherein the data region pattern has a plurality of signal holding magnetic tracks, which are arranged at equal spaces in the radial direction of the substrate and formed in a circular ring-shaped pattern, and nonmagnetic guard belts, which are situated between the magnetic tracks adjoining in the radial direction of the substrate and magnetically divide the magnetic tracks in the radial direction of the substrate, the magnetic tracks being configured so that the magnetic occupancy of the data region pattern is 65% or more, and
each of the servo region patterns has a repetitive pattern region which is substantially radially continuous at least in the radial direction of the substrate and includes magnetic and nonmagnetic portions arranged alternately in the circumferential direction of the substrate, the magnetic occupancy of the repetitive pattern region of the servo region pattern being about 50%, a circumferential length of the repetitive pattern region along the circumferential direction of the substrate being 0.01 mm or more.

5. A magnetic disk according to claim 1, wherein the recording regions are provided individually on the obverse and reverse surfaces of the substrate and patterned depending on the presence of a magnetic material, and the servo region patterns on the obverse side of the substrate and the servo region patterns on the reverse side of the substrate are different patterns and are formed in mirror-image symmetry so as to be coincident in clockwise and counterclockwise directions.

6. A magnetic disk according to claim 2, wherein the recording regions are provided individually on the obverse and reverse surfaces of the substrate and patterned depending on the presence of a magnetic material, and the servo region patterns on the obverse side of the substrate and the servo region patterns on the reverse side of the substrate are different patterns and are formed in mirror-image symmetry so as to be coincident in clockwise and counterclockwise directions.

7. A magnetic disk device comprising:
a magnetic disk according to claim 1;
a drive unit which supports and rotates the magnetic disk at a constant speed;
a head which performs information processing for the magnetic disk; and
a head actuator which radially moves the head with respect to the magnetic disk,
the magnetic disk being located in a direction such that each of the servo region patterns and a movement path of the head on the magnetic disk are in line with each other.
